(19) United States
(12) Patent Application Publication
(10) Pub. No.: US 2023/0167882 A1
(43) Pub. Date: Jun. 1, 2023

(54) LINK CHAIN SYSTEMS PRODUCING CONTINUOUS CHANGES IN VELOCITY AND ACCELERATION

(71) Applicant: Gregory Vern Bean, Bloomington, IN (US)

(72) Inventor: Gregory Vern Bean, Bloomington, IN (US)

(21) Appl. No.: 18/095,525

(22) Filed: Jan. 10, 2023

Related U.S. Application Data
(63) Continuation-in-part of application No. PCT/US21/41317, filed on Jul. 12, 2021.

(51) Int. Cl. F16H 7/06; F16G 13/07

(52) U.S. Cl. CPC F16H 7/06; F16G 13/07

(57) ABSTRACT

A link chain system includes a guided endless chain having multiple links, the links having hinge axes where they join with neighboring links, the links having a length L between the respective hinge axes of the links; a chain path along which the hinge axes are guided when driven such as by a drive wheel or sprocket or by any external drive force, the chain path having no discontinuities of curvature and no discontinuities of tangency; and the chain path having a constant length in links L independent of the relative phase position of the links of chain along the path. The link chain system can include a drive sprocket or drive wheel and transition curves of the chain path to and from the drive sprocket or drive wheel and a straight-to-straight transition curve.

### FIELD

The current disclosure relates to link chain systems, particular to guided link chain systems capable of fast and smooth operation.

### BACKGROUND

So-called chordal effects cause speed variation (and position and/or height variation) in circular-sprocket or circular-drive-wheel driven link chains. The size of the speed variation decreases as the size of the drive wheel of sprocket relative to the link length increases (as the number of sprocket teeth increases, for instance), but does not go to zero. Percentage speed variation as a function of number of sprocket teeth from 6 to 32 is shown in FIG. 1 (Prior Art).

This percentage variation is only part of the story, however. A graph of a linear speed variation over time for link chain driven by an 8-tooth sprocket is shown in FIG. 2 (Prior Art). As seen in the graph, the linear speed minima are moments of high acceleration (high rate of change in speed—nominally instantaneous change) indicative of relatively high momentary forces. The sharpness of the nominally instantaneous change is reduced—but the change is not eliminated—by using a larger sprocket as seen in FIG. 3 (Prior Art) for a 24-tooth sprocket. Even the smaller variation of chain speed (and position) with larger sprockets still includes a (nominally) instantaneous change in velocity, and the magnitude of the associated forces and generally grows as the square of chain speed. These non-uniformities lead to undesirable effects in certain applications, for example, they can limit operating speed and/or durability and can contribute to other undesirable effects such as noise, wear, chain or chain belt surge (such as in conveyors), lowered efficiency, etc. Also, larger sprockets can be unacceptable or undesirable in space-limited applications.

Further, drive wheels or drive sprockets are not the only components that introduce speed variation in a linked belt or chain. Other curves in a link chain path such as idler wheels or idler sprockets, nosebars and nose-rollers, and curved guides of any shape, such as conveyor chain carryway slope changes—can also introduce speed variation, though typically of lesser degree.

### SUMMARY

Link chain systems producing only continuous changes in velocity and acceleration—in other words, producing no instantaneous changes in velocity and no instantaneous changes in acceleration (or in other words “zero impact”)—are possible. The present disclosure describes such systems.

One embodiment of a link chain system as disclosed includes a guided endless chain having multiple links, the links having hinge axes where they join with neighboring links, the links having a length L between the respective hinge axes of the links. The system further includes a chain path along which the hinge axes are guided when driven such as by a drive wheel or sprocket or by any external drive force, the chain path having no discontinuities of curvature and no discontinuities of tangency; and the chain path having a constant length in links L independent of the relative phase position of the links of chain along the path.

The link chain system can include a drive sprocket or drive wheel and transition curves of the chain path to and from the drive sprocket or drive wheel.

The link chain system can also include a straight-to-straight transition curve of the chain between a first straight portion of the chain and a second straight portion of the chain path, the straight-to-straight transition curve having a length measured in lengths of link length L of greater than one and not more than two.

Specific advantages will be discussed below.

### BRIEF DESCRIPTION OF THE FIGURES

FIG. 1 (Prior Art) is a graph of speed variation as a function of sprocket tooth count.

FIGS. 2 and 3 (Prior Art) are graphs of speed variation over time produced by “chordal action.”

FIG. 4 is a diagram of a transition curve for eliminating chordal speed variations and any sudden changes in both velocity and acceleration for a chain moving onto or off of a sprocket or drive wheel.

FIGS. 5 and 6 are diagrams of distances and forces which can be considered in the derivation of curves of the type shown in FIG. 4

FIG. 7 is a diagram of another embodiment of a curve of the type shown in FIG. 4.

FIG. 8 is a graph of the needed chain wrap on a sprocket or drive wheel, in degrees, as a function of sprocket tooth count when using curves of the type shown in FIG. 4.

FIG. 9 is a diagram illustrating another embodiment of a curve of the type shown in FIG. 4 together with rollers and a rollerway which may be used to allow chain hinge axes to follow curves of the type shown in FIG. 4.

FIG. 10 is a diagram of a sliding guideway which may be used to allow chain hinge axes to follow curves of the type shown in FIG. 4.

FIG. 11 is a cross-sectional diagram of a portion of a chain path illustrating potential uses of curves of the type shown in FIG. 4.

FIG. 12 is a cross-sectional diagram of a chain with guide rollers offset from the chain hinge axes, together with a rollerway useful with such rollers to cause the chain hinge axes follow curves of the type shown in FIG. 4

FIG. 13 is a force diagram useful to derive transition curves similar to the curve of FIG. 4, but from a curved path to a curved path rather than from a straight path to a curved path.

FIGS. 14 and 15 are diagrams two embodiments of transition curves from a curved path to a curved path.

FIGS. 16 and 17 are diagrams of dimensions and forces which can be used to derive a transition curve similar to that of FIG. 4, but from a straight path to a straight path.

FIG. 18 is a diagram of an embodiment 1 of a transition curve from a straight path to a straight path.

FIG. 19 is a diagram illustrating in part a method of determining a surface of a sliding guide for a link chain or link belt.

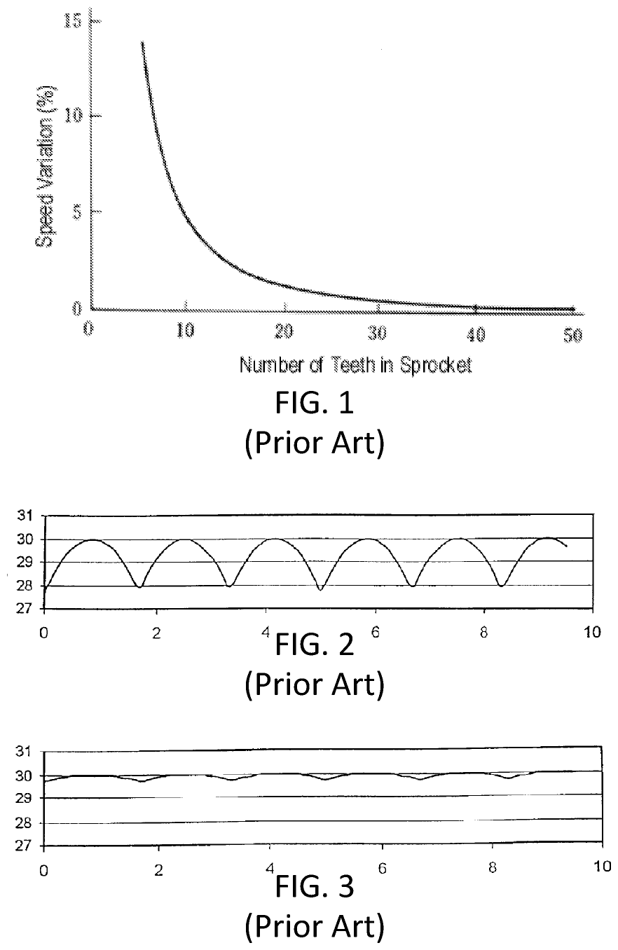

### DESCRIPTION

Although chain and/or belt guides have been proposed in the past to reduce or nominally eliminate chordal speed variation, such previously proposed guides—even if they nominally eliminate linear speed variation—often have produced excessive or unnecessary impact and/or wear between the chain or belt and the guides and/or between the chain or belt and the sprockets or drive wheels. This is because such guides known in the past have not avoided discontinuities in the velocity and/or in the acceleration of the belt or belt modules. What has not been disclosed in the past is the ideal chain paths described herein which allow a link chain to transition, within the length of a single link, from linear to circular motion, with zero chordal speed variation and with zero impact (with zero impact defined as no instantaneous changes in velocity and acceleration). There is one unique curve for the chain or belt links to follow (for a given drive wheel or sprocket tooth count) which produces such a transition within the length of one link.

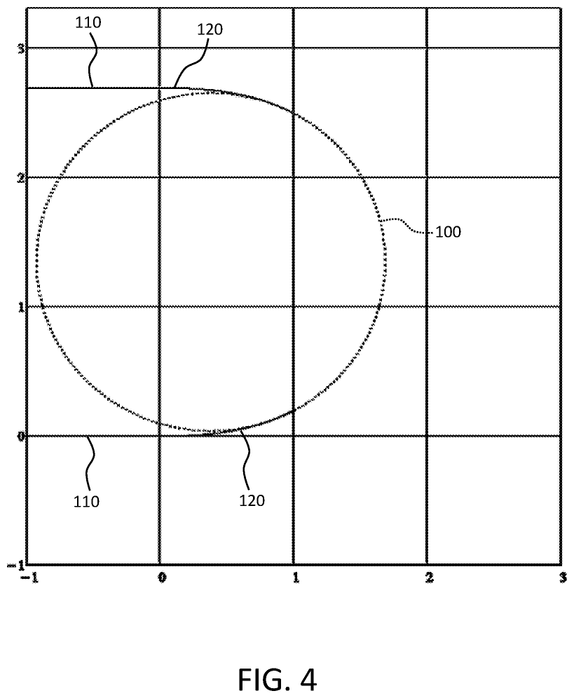

An example of this unique curve for chain links to follow (more specifically, for the hinge points of the links to follow) is shown in FIG. 4, for an 8-tooth sprocket or drive wheel with a nominal 180-degree wrap (with wrap defined as the total change of direction between the straight portions of the hinge axis path from before to after the sprocket). The dotted circle represents a sprocket or drive wheel pitch circle 100 (at the chain or belt hinge points). The straight lines 110 from (−1,0) to (0,0) and from (−1, 2.7) to (0, 2.7) represent one module/link length of distance (hinge point to hinge point distance) along a linear chain or belt path such as a belt carryway. The curves 120 (rightward in the figure from x=0) are the unique transition curves or transition paths for the hinge points of the chain or belt to follow for an ideal transition from linear motion along the lines 110 to circular motion around the sprocket, for an 8-tooth sprocket. (Units of the grid in the figure are shown in link lengths.)

As shown in the figure, the transition curves 120 are indistinguishable—in curvature, position and direction—both from straight lines 110 of the linear chain link path (where they meet the straight lines) and from sprocket or drive wheel pitch circle 100 (where they meet the pitch circle 100). This reflects that there is no instantaneous change of velocity or acceleration required (either in the direction along the module hinge pin path, or in the direction perpendicular to it) for chain or belt links following the curves 120. In addition to fulfilling these conditions, the curves 120 are at the same time so shaped as to eliminate speed variation between chain links on the sprocket or drive wheel and the chain links on the linear chain link path(s) (paths along the direction of the straight lines 110). Simultaneously satisfying these conditions, within one link length, produces the unique shape of the curves 120.

A derivation of an analytic expression for the curves 120 may be conducted as follows:

Conditions: A chain link transition path, of one link length, is to be shaped such that (1) the chain will move with constant linear speed on a linear chain path when driven (e.g., pulled) at a constant rotational speed by an associated circular sprocket; (2) in traveling along the linear chain path, then along the transition path, then through the point of engagement with the sprocket and continuing on around the sprocket with rotation of the sprocket, the chain link (and the chain links and the chain as a whole) undergoes no instantaneous changes in velocity (i.e., no instantaneous changes in speed and no instantaneous changes in direction—only gradual changes); and (3) in traveling along the linear chain path, then along the transition path, then through the point of engagement with the sprocket and continuing on around the sprocket with rotation of the sprocket, the chain link (and the chain links and the chain as a whole) undergoes no instantaneous changes in acceleration.

Note that, if each of the hinge axes of the links moves so as to meet the conditions above, then each of the links and the chain as a whole does so as well. Accordingly, a place to start is to determine the desired path of the hinge axes of the links, so that these three conditions are met.

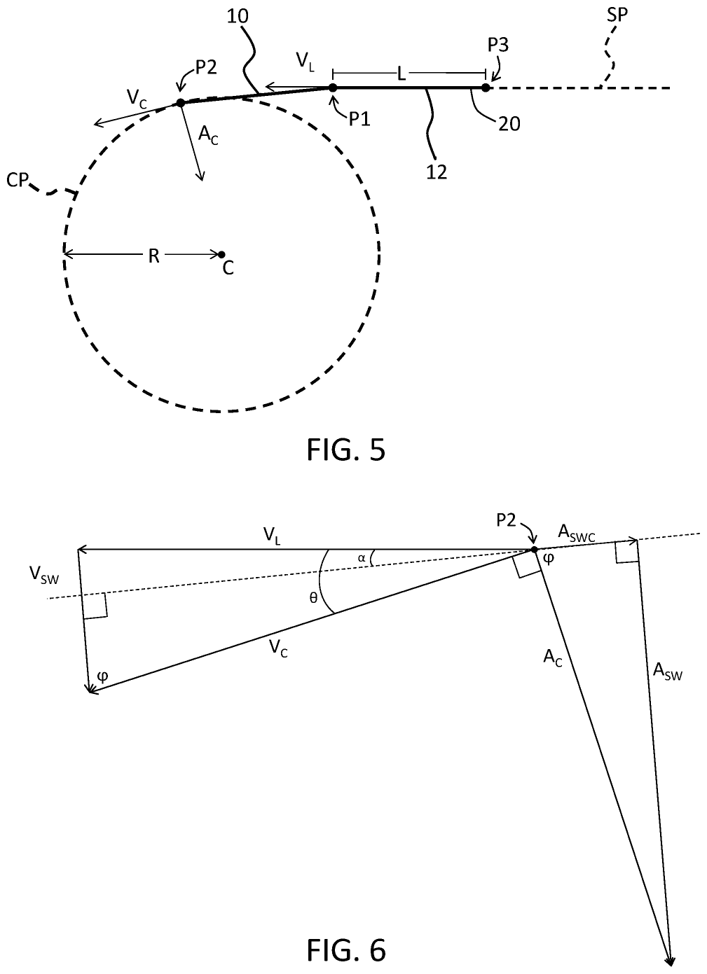

With reference to FIG. 5, two representative links 10, 12 are shown, each of length L, with the link 12 on a straight path SP and with a transitional link 10 bridging a transition path (transition path not shown in FIG. 5, see transition path TP of FIG. 6, described below). The desired transition path may be determined by first finding a desired position of the transition link 10, having one end (one hinge axis) P1 on the straight path SP and the other end (hinge axis) P2 on a circular path CP to be traveled by the links 10, 12 when said links are engaged by a sprocket. The desired position to be found is the position such that the hinge axis P1 of the link 10 is capable of moving with a linear velocity V_{L}, with zero acceleration, while the hinge axis P2 of the link 10 is simultaneously capable of moving with a tangential circular velocity V_{C} and with a centripetal acceleration A_{C} directed toward the center C of the circular path CP, where AC=(V_{C})²/R, where R is the radius of the circular path CP. It should be noted that V_{C} is actually slightly greater than V_{L}, and this may be understood in various ways. One way to understand is to note that the number of link joints passing a given point, per unit time, needs to be the same on the straight path SP as on the circular path CP. But for one hinge axis to pass from its present location to the position of the hinge axis, hinge axes on the straight path SP only have to travel the length L of one link, while hinge axes on the circular path CP have to travel a slightly longer, circular path, hence V_{C}>V_{L}.

The position of transition link 10 can also be described as the position of the transition link 10 such that one hinge axis, hinge axis P1, is capable of ideal linear movement (with respect to both velocity and acceleration), while the other hinge axis, hinge axis P2, is simultaneously capable of ideal circular movement (with respect to both velocity and acceleration), all with no deformation of link 10. Once this position is found, then the desired transition path may be determined by mathematically moving the trailing link axis, link axis P3, of the link 12 leftward in the figure along the straight path SP until it reaches the depicted location of link axis P1, while simultaneously moving the leading end, hinge axis P2, of the link 10 around the circular path CP (at |V_{C}|/|V_{L}| times the speed of the movement of P3), while allowing the hinge axis P1 to bend as needed thereby tracing the desired path.

This may be done by finding the intersection (the upper intersection, in this case) of two circles of radius L, one centered on P3, as P3 moves at the speed of V_{L} along the straight path SP, and one centered on P2, as P2 moves at the speed of V_{C} along the circular path CP. The location of the (upper) intersection of the circles is then the location of P1, which traces the transition curve.

To find the starting position and orientation of the transition link 10 (bridging the ideal transition curve), and the position of the circular path CP, relative to both the straight path SP and to the radius of the circular path R, we can diagram certain components of velocity and acceleration and total velocity and acceleration at hinge axis P2 as shown in the diagram of FIG. 6.

In FIG. 6, two velocity components and the total velocity of hinge axis P2 make up the left-most triangle. (The dotted line represents the direction along the transition link 10.) The velocity components consist of (1) the linear velocity V_{L} (equal to the velocity of hinge axis P1 when the transition link 10 is in the desired position shown in Figure A); and (2) a “swing velocity” V_{SW} which is the velocity, in a direction perpendicular link 10 (that is, to the dotted line representing the direction of link 10), generated by angular velocity or “swing” of the link 10 around the hinge axis P1. (The direction along link 10 lies at an angle α below the direction of V_{L}, as shown.) These two velocity component vectors must vector-add to give the tangential circular velocity vector V_{C}, as shown in the figure.

Two acceleration components and total acceleration of hinge axis P2 make up the right-most triangle in FIG. 6. The acceleration components consist of (1) a “swing acceleration” A_{SW}, which is the acceleration of hinge axis P2 in a direction perpendicular to link 10, generated by angular acceleration of the link 10 around the hinge axis P1; and (2) a “swing-centripetal acceleration” A_{SWC}, in a direction along the link 10 back toward the hinge axis P1, generated by the angular velocity or “swing” of the link 10 around the hinge axis P1. These two acceleration component vectors must vector-add to give the circular acceleration A_{C} (which is perpendicular to the circular tangential velocity V_{C}), as shown in the figure.

For a given link length L and a given radius R of the circular path CP, the task is to find the desired position of the transition link 10, relative to the straight path SP and the circular path CP (and thus the relative positions of the paths CP and SP as well), such that the conditions in FIG. 6 are satisfied along with the two centripetal acceleration relations A_{C}=(V_{C})²/R and A_{SWC}=(V_{SW})²/L. To make the problem easier, we may assign the value 1 to L without loss of generality, if other dimensions are specified relative to L. We may likewise assign the value 1 to the linear velocity V_{L} without loss of generality, as long as other velocities are specified relative to V_{L}.

One way these relative relationships can be established and preserved is with the use of a variable N representing the number of links which fit around the circumference of the circular path CP (the effective number of “teeth” of the sprocket or driving wheel). R may then be given in terms of N (with L=1) as

$$R = \frac{1}{2 \cdot sin ( \frac{π}{N} )} \qquad ( 1 )$$

and V_{C} may be given in terms of N (with V_{L}=1) as

$${V}_{c} = \frac{π}{N \cdot sin ( \frac{π}{N} )} . \qquad ( 2 )$$

Continuing to use R and V_{C} as shorthand for the above expressions, and taking L and V_{L} as 1, then from the law of cosines expressed for cosine(φ) from the velocity triangle in FIG. 6, together with the definition of cosine(φ) from the acceleration triangle in FIG. 6, and using the identity cosine(φ)=cosine(φ), we have

$$\frac{{V}_{C}^{2} + {V}_{S W}^{2} - {V}_{L}^{2}}{2 \cdot {V}_{C} \cdot {V}_{SW}} = \frac{{A}_{S W C}}{{A}_{C}} , \qquad ( 3 )$$

now using vector magnitudes only, with the trigonometric expressions having accounted for the respective vector directions.

Applying the (two) formulas for centripetal acceleration relations to the right side (and remembering that L=1) gives:

$$\frac{{V}_{C}^{2} + {V}_{SW}^{2} - {V}_{L}^{2}}{2 \cdot {V}_{C} \cdot {V}_{s W}} = \frac{{V}_{SW}^{2}}{\frac{{V}_{C}^{2}}{R}} . \qquad ( 4 )$$

Collecting on V_{SW} gives:

$$2 \cdot {V}_{C} \cdot {V}_{SW}^{3} + \frac{- {V}_{c}^{2}}{R} \cdot {V}_{SW}^{2} + \frac{{V}_{C}^{2} - {V}_{C}^{4}}{R} = 0 \qquad ( 5 )$$

which is of the form:

C1·V_{SW}³+C2·V_{SW}²+C3=0 (6)

with constants

$$C 1 = 2 \cdot {V}_{C} , \\ C 2 = \frac{- {V}_{c}^{2}}{R} , \\ and C 3 = \frac{{V}_{C}^{2} - {V}_{C}^{4}}{R} . \qquad ( 7 )$$

(Note that all these constants may be expressed as functions of N.)

Using a combined constant CC for compactness, defined as

$$C C = {( \sqrt{\frac{C {3}^{2}}{4 \cdot C {1}^{2}} + \frac{C {2}^{3} \cdot C 3}{27 \cdot C {1}^{4}}} - \frac{C {2}^{3}}{27 \cdot C {1}^{3}} - \frac{C 3}{2 \cdot C 1} )}^{\frac{1}{3}} \qquad ( 8 )$$

there is a real solution of the form

$${V}_{SW} = C C - \frac{C 2}{3 \cdot C 1} + \frac{C {2}^{2}}{9 \cdot C 1 \cdot CC} \qquad ( 9 )$$

which is solely a function of N upon making the appropriate substitutions.

With V_{SW} found, θ may then be found using the law of cosines:

$$θ = acos ( \frac{1 + {V}_{C}^{2} - {V}_{SW}^{2}}{2 \cdot {V}_{C}} ) \qquad ( 10 )$$

and φ may be found from θ using the law of sines:

$$φ = asin ( \frac{sin ( θ )}{{V}_{S W}} ) . \qquad ( 11 )$$

This effectively completes the process of finding the starting position (the position bridging the transition curve) of link 10 of FIG. 5. Next we mathematically trace the hinge axis P1 through one link length of motion to generate the desired transition path.

Taking hinge axis P1 in FIG. 5 as the origin in Cartesian coordinates with positive y up in the figure and positive x to the right, then the center C of the circular path CP (the center of the sprocket pitch circle) is located at (X_{C}, Y_{C}), with

X_{C}=−sin(θ+φ)+R·sin(θ), Y_{C}=−R·cos(θ+φ) (12).

A point moving continuously for one link's distance at relative velocity V_{C} along the circular path CP beginning at P2 may then be expressed parametrically as [X_{CP}(x), Y_{CP}(x)], with

$${X}_{C P} ( x ) = {X}_{C} - R \cdot sin ( \frac{2 π}{N} x + θ ) , {Y}_{C P} ( x ) = {Y}_{C} + R \cdot cos ( \frac{2 π}{N} x + θ ) \qquad ( 13 )$$

as x goes from 0 to 1. A point moving continuously for one link's distance along the straight path SP at relative velocity V_{L} beginning at P3 may be expressed, parametrically, as [X_{SP}(x), Y_{SP}(x)], with

X_{SP}(x)=1−x, Y_{SP}(x)=0 (14)

as x goes from 0 to 1.

To find a parametric expression [X_{TP}(x), Y_{TP}(x)] for the points of the desired transition path traveled by the hinge axis P1, we can use a parametric expression for the intersection of two circles of radius 1 (again taking L=1), one circle centered at [X_{CP}(x), Y_{CP}(x)] and the other at [X_{SP}(x), Y_{SP}(x)], as x goes from 0 to 1. For this purpose, if we define

$$proportion ( x ) = \frac{\sqrt{4 - {( {Y}_{S P} ( x ) - {Y}_{C P} ( x ) )}^{2} - {( {X}_{S P} ( x ) - {X}_{C P} ( x ) )}^{2}}}{2 \cdot \sqrt{{( {X}_{S P} ( x ) - {X}_{C P} ( x ) )}^{2} + {( {Y}_{S P} ( x ) - {Y}_{C P} ( x ) )}^{2}}} \qquad ( 15 )$$

then X_{TP}(x) and Y_{TP}(x) can be expressed as

$${X}_{T P} ( x ) = \frac{{X}_{C P} ( x ) + {X}_{S P} ( x )}{2} - ( {Y}_{C P} ( x ) - {Y}_{S P} ( x ) ) \cdot proportion ( x ) \\ and \qquad ( 16 )$$

$${Y}_{T P} ( x ) = \frac{{Y}_{C P} ( x ) + {Y}_{S P} ( x )}{2} + ( {X}_{C P} ( x ) - {X}_{S P} ( x ) ) \cdot proportion ( x ) \qquad ( 17 )$$

where the main operators “—” and “+” of expressions (16) and (17) above select for the upper intersection of the two circles or radius 1 (and would be exchanged with each other to select for the lower intersection).

The result is that a unique transition path, [XTP(x), YTP(x)], as x goes from 0 to 1, is given, with its shape wholly determined by the parameter N, which is equivalent to the number of links that fit around the sprocket or other drive wheel, or the effective number of teeth on a sprocket or drive wheel, with its size or scale determined by the link length L.

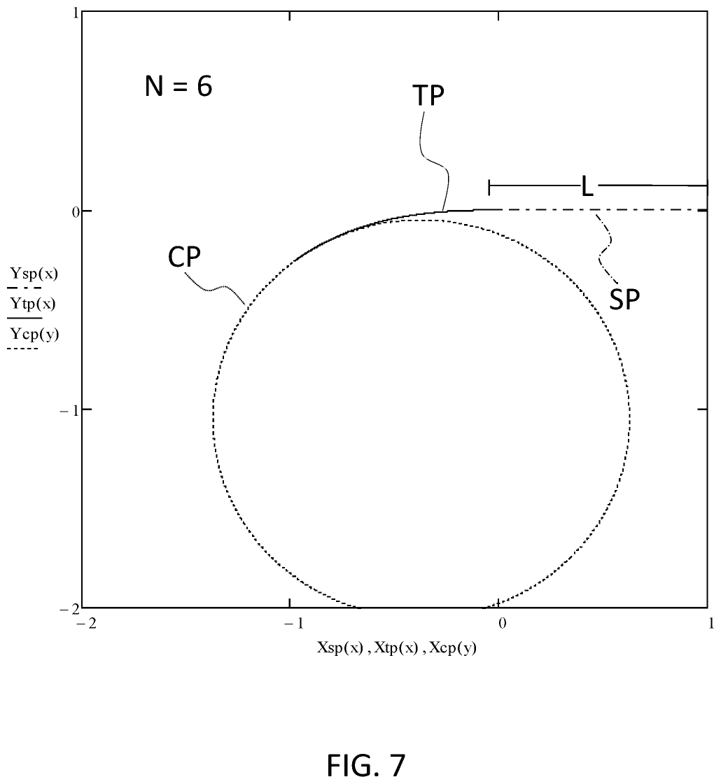

FIG. 7 shows a graph of [XSP(x), YSP(x)] (the straight path SP); [XCP(x), YCP(x)] (the circular path CP); and [XTP(x), YTP(x)] (the transition path TP for the hinge axes to follow to achieve the desired conditions), all for N=6 (in other words, for a six-tooth sprocket or equivalent drive wheel). [XSP(x), YSP(x)] and [XTP(x), YTP(x)] are shown from x=0 to x=1, or for one link length of total travel, while [XCP(x), YCP(x)] is extended to show the complete “pitch circle” of the sprocket (minus the short segment cut off at the bottom of the figure). The graph was generated in Mathcad using the equations given above or their mathematical equivalents.

Note that the transition path TP shown in FIG. 7 departs from the straight path SP, and arrives at the circular path CP, very gradually, as there will be no discontinuities in velocity or acceleration of a hinge axis (or an associated link) following the three paths in succession when driven/pulled by a sprocket having a pitch circle matching the circular path CP.

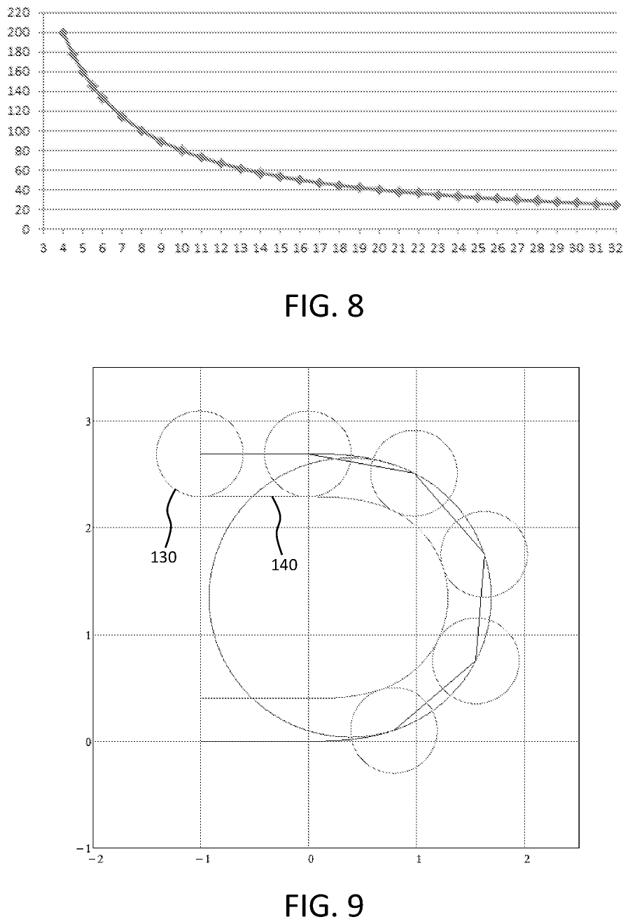

Note also that sufficient chain wrap is needed. Chain wrap (angular chain wrap) is defined herein (as noted above) as the total angular change of direction (such as in degrees) between the (nominally) straight portions of the hinge axis path from before the sprocket or drive wheel and transition path to after the sprocket or drive wheel and transition path. The angular chain wrap must be sufficiently large such that at least one full link length (or in other words, a hinge-axis-to-next-hinge-axis length) lies (or can lie) on the circular path around the sprocket or drive wheel pitch circle between the two transition curves. This requirement sets a limit on the practical minimum sprocket tooth number of about 4½ teeth (or in other words, 9 sprocket or chain wheel teeth used with double pitch chain) in the case of a 180-degree chain wrap. FIG. 8 shows the minimum wrap needed (in degrees on the y-axis) as a function of sprocket tooth count (on the x-axis) in the above embodiments. A tooth count below about 4.5, such as 4-tooth sprocket, for instance, is not generally practically possible, since the chain links going on and coming off the sprocket or chain wheel would interfere with each other (at the needed wrap of about 200 degrees).

Although transition curves disclosed herein, when used for higher tooth-count sprockets, may appear small and insignificant, their effects can be quite significant. By using a guide or guides or other mechanisms or means to cause the link axes to follow the disclosed curves, the following is achieved: (1) There is no periodic vertical “rise and fall” chordal motion of the chain—only a smooth fall away of each successive from the linear path. (2) There is no periodic linear speed variation generated by a constant-speed drive sprocket or drive wheel—whatever the drive sprocket does rotationally, the belt or chain does linearly, with no periodic variation. (3) There is no periodic impact between the chain and the sprocket. Just as a link (or link hinge pin) reaches full engagement with the sprocket, it simultaneously reaches zero velocity and zero acceleration in the rotating frame of reference of the sprocket (zero velocity and zero acceleration relative to the sprocket). (4) There is no periodic impact between a linear guideway and links fed, such as from an idler, along a transition curve of this type. Just as a link (or link hinge pin) reaches alignment with the linear path of the linear guideway, it reaches zero acceleration and zero velocity in the linearly translating frame of reference of the linear portion of the chain or belt.

One way to allow a link chain or belt to follow the desired path is by using a chain with rollers 130 on or concentric with the hinge axes of the links, and providing a guide or rollerway 140 for the rollers 130 to follow, as diagrammed in FIG. 9. The shape of the rollerway 140 can be found simply tracing the location of a perpendicular distance to the inside of the roller hinge path at a distance of the roller radius. Guides or rollerways such similar to guide or rollerway 140 are useful with any of the ideal curves discussed above (or below). A guide can of course only extend up to the associated sprocket pitch circle—that is, it need not extend all the way around the pitch circle.

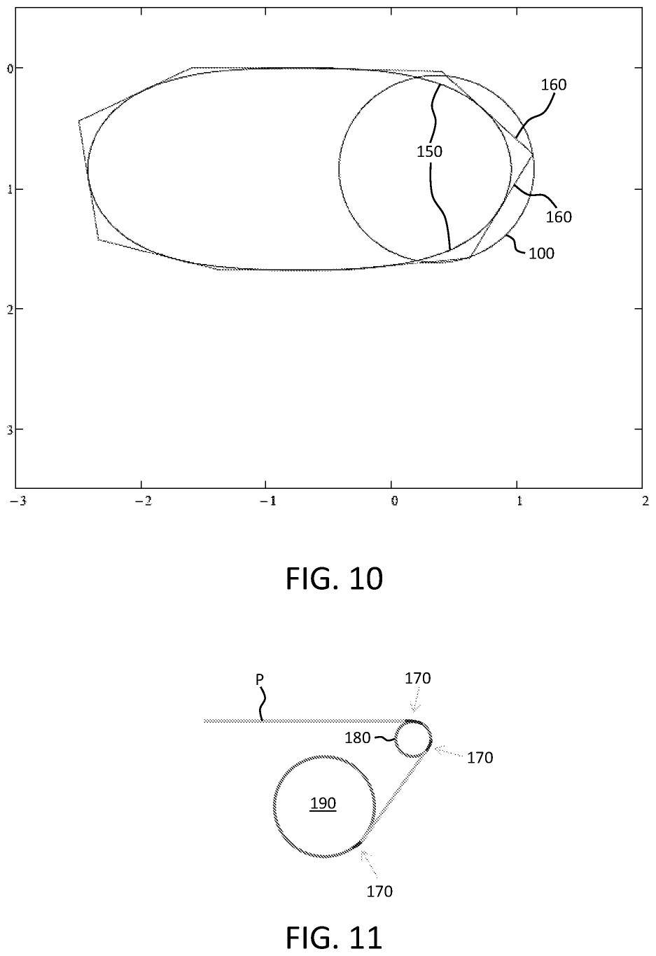

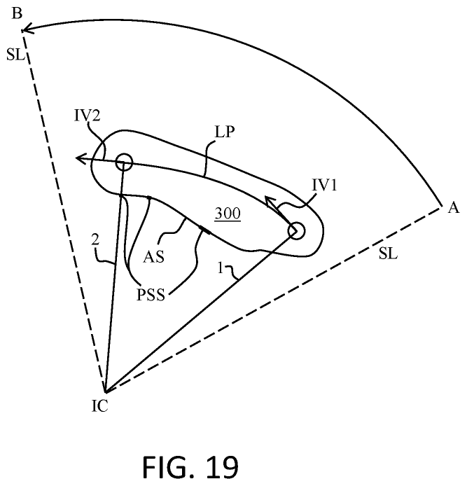

Additional alternatives include sliding-surface guides, the shape of which can be determined by mathematically tracing the path of a link from the straight onto the transition curve and then from the transition curve onto the pitch curve of the sprocket or drive wheel, while at each point along the way, finding the instant center of the link at that point and capturing any point(s) on the guide-facing surface of the link at which (based on the surface geometry of the link) the surface of the link is perpendicular to the instant center. The guide surface is then determined by the inward-most (closest to the guide side) of the captured points. This technique is partly illustrated in the diagram of FIG. 19. In FIG. 19, a link 300 is shown having an arbitrarily shaped surface AS facing the inside of a chain path. A portion of a link path LP is shown which links such as link 300—or the hinge points thereof, shown by the circles at each end of the link 300—are intended to follow. The instant center IC of the link 300, in the position shown and following the link path LP, can be found by finding the intersection any to lines perpendicular to the instantaneous velocity at a respective separate points on the link 300. Since the links follow the link path LP, we can just take line 1 and line 2 each perpendicular to the tangent of the link path LP at a respective hinge point of the link 300. The intersection of lines 1 and 2 is thus the location of the instant center IC. To find the desired points on the guide-facing surface, arbitrarily shaped surface AS, we can sweep a “sweep line” SL extending from the instant center IC across the link 300 from A to B, and capture any points on the surface AS at which the surface AS is perpendicular to the sweep line. Examples of such points, which may be referred to as perpendicular surface segments PSS, are shown by thickened line sections on the surface AS. After the link 300 is moved through every position along the complete link path LP (of which only a portion is shown), then, as mentioned above, the resulting guide surface is determined by the inward-most (closest to the guide side and to the inside of the link path LP) of the captured points. This technique can be used to determine a sliding guide for flat links and for links having other profiles as well. A guide 150 resulting from this technique (for flat links 160 of essentially no thickness) is diagrammed in FIG. 10, for a pitch circle 100 as shown. (This example is for the extreme case of N=4.5.) Naturally guides for practical flat links will have an offset of the guide path beyond that in the diagram of FIG. 10, perpendicular to the link centerline (perpendicular to the guide path shown above), corresponding to the thickness of the chain link from the centerline to the guide-facing side.

Transition curves similar to those discussed above can be used to eliminate linear speed variations introduced by circular idlers, circular nosebars, and nose-rollers in conveying and other chains although the maximum tightness (that is, the minimum distance) of any resulting transfers may be reduced a little. An example of locations for such transitions to be used is shown by the arrows 170 in the diagram of FIG. 11, in which a chain path P is shown passing over a nose roller 180 and on to a sprocket or drive wheel 190.

The ideal curve can be intentionally departed from, to a slight degree, to provide for optimized performance over expected lifetime wear. For wear of hinge joints for example, the effective chain pitch may lengthen, so the transition path and associated guide(s) (if any) can be designed for slightly longer link lengths than those actually provided in a new link chain system, which system will then wear in toward more optimal performance.

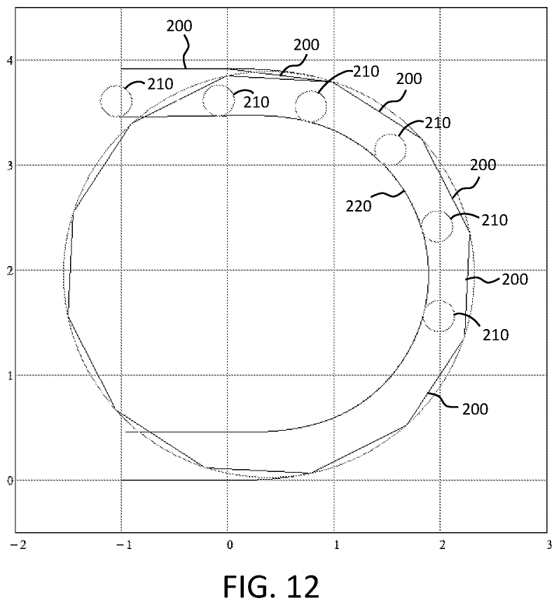

Rollers 210 and rollerways 220 for guiding link axes along the (or an) ideal path can also be used with rollers which are not concentric with hinge axes. An example is depicted diagrammatically in FIG. 12 in which, a chain design includes links 200 with a support roller 210 for each link 200, displaced downward and backward (that is, downward and leftward at the top of the figure) from the closest hinge axis location and from the axis-to-axis span of the link 200 to which it is attached. With the rollers 210 beneath the chain (when considered from the top side), the top surface of the chain can thus have a flat, hidden hinge design, if desired. The asymmetry of the support rollers relative to the links allows stable support of loads on the rollerway 220 through the links 210 and results in a related asymmetry in the rollerway 220 (as may be seen by comparing the top of the line representing the rollerway 220, which has a slight upward bulge, with the bottom which has no corresponding downward bulge) in order that the links 210 follow the ideal curve. (This is also an example of the power of having an analytic expression for the ideal curve, since other curves such as the path of the offset support rollers 210 and resulting (asymmetrical) rollerway 220 are easily determined directly from the ideal transition curves derived above.)

Ideal curves can be derived for other transitions than from straight to circular motion. For example, ideal curves for circular to circular motion transitions, within a single link length, and meeting the same other desired conditions, may derived in similar fashion to the transition from straight to circular described above.

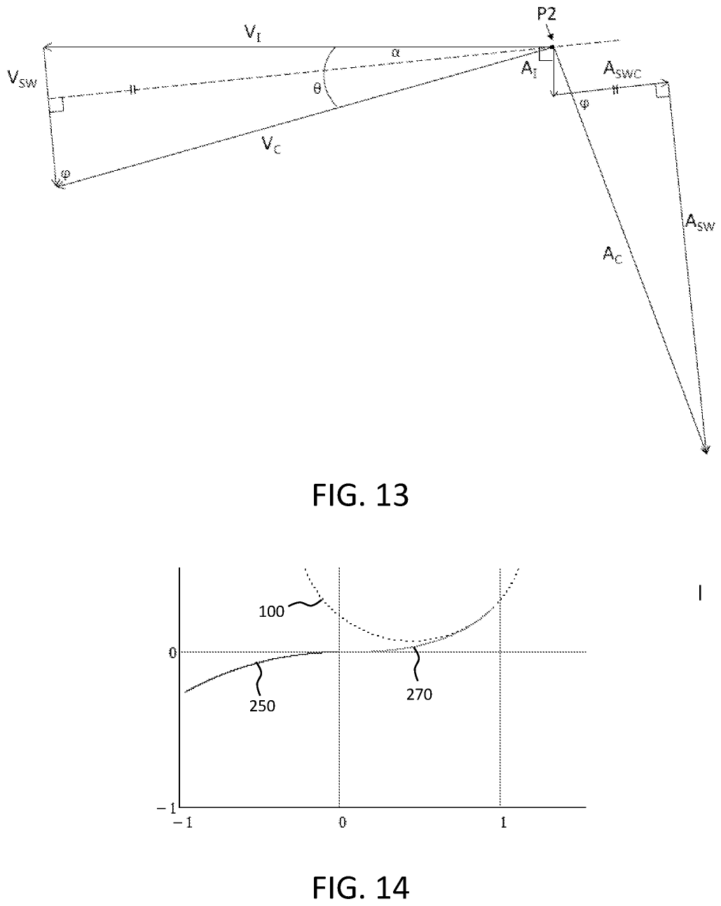

With reference to FIG. 13, the accelerations and velocities which must vector-add are similar to that of FIG. 6, with the differences (1) that one of the velocities at P2 is now labeled V_{I} (“initial velocity” since the motion of the trailing end of the transition link at P1 is no longer linear) and (2) that an additional acceleration A_{I} (“initial acceleration” perpendicular to V_{I}) is present, as the link axis at P1 is itself in circular motion. By use of similar triangles and the law cosines, it can be shown from the relations in FIG. 13 that

$${V}_{S W} = \frac{\frac{K {1}^{2}}{9} + \frac{K {2}^{2}}{36 \cdot {V}_{C}^{2}} + \frac{K 1 \cdot K2}{9 \cdot {V}_{C}}}{C C} + \frac{K 2 + 2 \cdot {V}_{C} \cdot K 1}{6 * {V}_{c}} + CC \\ where \qquad ( 18 )$$

$$K 1 = \frac{{A}_{I}}{{V}_{I}} , \\ K 2 = \frac{{V}_{C}^{2}}{{R}_{C}} - K 1 \cdot {V}_{C} \\ and \qquad ( 19 )$$

$$CC = {( \frac{K {1}^{3}}{27} + \frac{K {2}^{3}}{216 \cdot {V}_{C}^{3}} + \frac{{V}_{C}}{K 2} + \sqrt{A 1 + A 2 + A 3} - A 4 )}^{\frac{1}{3}} \\ where \qquad ( 20 )$$

$$A 1 = \frac{{V}_{C}^{2} \cdot K {2}^{2}}{16} + \frac{K {2}^{4}}{432 \cdot {VC}^{2}} - \frac{{V}_{I}^{2} \cdot K {2}^{2}}{8} + \frac{K {1}^{2} \cdot K {2}^{2}}{36} \qquad ( 21 )$$

$$A 2 = \frac{{V}_{I}^{4} \cdot K {1}^{2}}{16 \cdot {V}_{C}^{2}} - \frac{{V}_{I}^{2} \cdot K {2}^{4}}{432 \cdot {V}_{C}^{4}} + \frac{{V}_{C} \cdot K {1}^{3} \cdot K 2}{54} \qquad ( 22 )$$

$$A 3 = \frac{K 1 \cdot K {2}^{3}}{72 \cdot {V}_{C}} - \frac{{V}_{I}^{2} \cdot K {1}^{3} \cdot K 2}{54 \cdot {V}_{C}} - \frac{{V}_{I}^{2} \cdot K 1 \cdot K {2}^{3}}{72 \cdot {V}_{C}^{3}} - \frac{{V}_{I}^{2} \cdot K {1}^{2} \cdot K {2}^{2}}{36 \cdot {V}_{C}^{2}} \\ and \qquad ( 23 )$$

$$A 4 = \frac{{V}_{I}^{2} \cdot K 2}{4 \cdot {V}_{C}} + \frac{K {1}^{2} \cdot K 2}{18 \cdot {V}_{C}} + \frac{K 1 \cdot K {2}^{2}}{36 \cdot {V}_{C}^{2}} \qquad ( 24 )$$

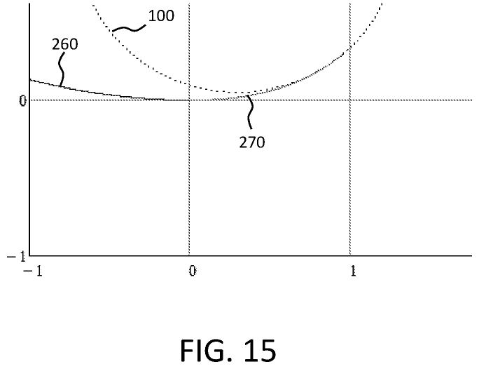

Having solved for V_{SW}, we can proceed similarly to equations 10-17 above to obtain the desired transition curve. Examples of transition curves produced in this way are shown in FIGS. 14 and 15. FIG. 14 shows a transition curve 270 from a downward facing circular curved link path 250 to an upward facing circular curved link path 100 or sprocket or the like. FIG. 15 shows a transition curve 270 from an upward facing circular curved link path 260 to an upward facing circular curved link path 100 or sprocket or the like. The transition paths 270 in both cases were obtained by the equations given above.

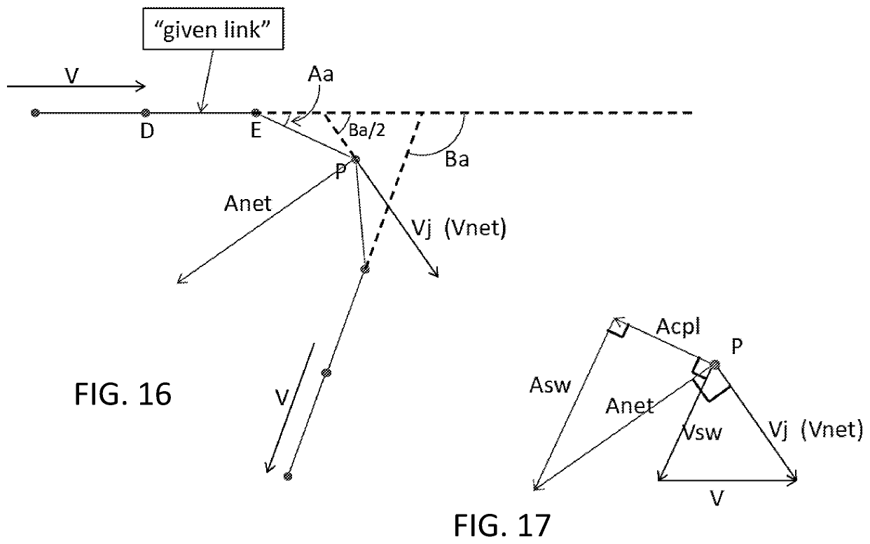

Of course it can be that not all turns in a guided link chain will or should contain a circular portion, such as a passage over a roller or sprocket, within or at the center of the turn. Accordingly, it is useful to be able to provide turn paths (link hinge axis paths) which cause no instantaneous changes in velocity or acceleration of the links and/or chains following other types of turn paths. An example for a non-circular turn path of two links in length is given next, with reference to the diagrams of FIGS. 16 and 17.

Let end points of two straight paths at an angle Ba (directional) relative to each other be symmetrically separated by a symmetrical bent two-link pair with the upper link at angle Aa relative to the upper straight, with 0<Aa<Ba/2, and with a central point P at the hinge axis between the links. (See FIG. 16.) Then as the links (or the whole chain) moves along the straight paths with velocity V, and the hinge axis in the two-link bridge is exactly at point P, the instantaneous velocity of the hinge axis at point P must be orthogonal to any opposing velocity components of the velocities V of the links on the straight paths. If this were not the case, the hinge axis could not maintain the same distance of one link length from both of the nearest hinge axes on the straight paths. In other words, Vj (the velocity of the hinge axis or “joint”) must be in the Ba/2 direction relative to the input (upper) straight section. (Angle “Ba” is as the angle of the turn full completed; Aa is a design variable, usually producing a well-behaved result within the range of from ⅕ to ¼ of Ba.)

From this required direction of the velocity of the link end at point P, the necessary swing velocity of the link moving on the input path can be found—the swing velocity (here in linear terms of the linear velocity at point P) must be enough that the sum of the swing velocity V_{SW} and the input straight section velocity (V=1) must add to a vector in the Ba/2 direction. From this, the magnitude of the swing velocity V_{SW} can be found:

$$Vsw ( Aa , Ba ) := \frac{sin ( \frac{Ba}{2} )}{sin ( Aa + \frac{π}{2} - \frac{Ba}{2} )} \qquad ( 25 )$$

From the magnitude of the swing velocity Vsw can be found the resulting magnitude Acpl of centripetal acceleration toward the link joint on the straight which is pivoting to produce Vsw (taking link length of 1 for ease of algebra) (see FIG. 17 for the vector diagrams):

Acpl(Aa,Ba):=Vsw(Aa,Ba)² (26)

The direction of Acpl is of course back along the swinging link toward the straight section, but the only acceptable direction for any net acceleration Anet at point P is Ba/2+π/4 (perpendicular to Ba/2). Accordingly, the magnitude of Asw, an acceleration at point P due to swing acceleration, may be found:

$$Asw ( Aa , Ba ) := \frac{Acpl ( Aa , Ba )}{tan ( \frac{Ba}{2} - Aa )} \qquad ( 27 )$$

Because we have assumed link length l, angular acceleration to produce Asw and angular velocity to produce Vsw have the same values as Asw and Vsw above. So we now have angular position, angular velocity, and angular acceleration measured at point D for a given link, and needed for the proper motion of point E at the end of the given link, both at the instant of point E entering the curve and at the instant point E reaches point P, as shown in the following table:

| | position | acceleration | velocity |
|---|---|---|---|
| before moving | 0 | 0 | 0 |
| off the input | | | |
| straight line | | | |
| upon reaching P | Aa | Vsw | Asw |
| | | (Aa, Ba) | (Aa, Ba) |

We need to find a function fitting these conditions. Then we will use the intersection of circles technique to find the shape of the remainder of the turn. A fifth order polynomial is one instance of a solution to the resulting differential equation. By choosing link length l and considering the motion in link length units through one link length, we can use a fifth order polynomial along the interval 0 to 1 to find solution of the form:

Ac·x⁵+Bc·x⁴=Cc·x³+Dc·x²=Ec·x=F (28)

Because the function and its first two derivatives are zero at x=0, D=E=F=0, and we are left with evaluating

Ac·x⁵+Bc·x⁴+Cc·x³ (29)

and its first two derivatives at x=1, giving the following three equations:

Ac+Bc+Cc=Aa (30)

5·Ac+4·Bc+3·Cc=Vsw(Aa,Ba) (31)

20·Ac+12·Bc+6·Cc=Asw(Aa,Ba) (32)

which gives

$$Ac ( Aa , Ba ) := 6 \cdot Aa + \frac{Asw ( Aa , Ba )}{2} - 3 \cdot Vsw ( Aa , Ba ) \qquad ( 33 )$$

$$Bc ( Aa , Ba ) := 7 \cdot Vsw ( Aa , Ba ) - Asw ( Aa , Ba ) - 15 \cdot Aa \qquad ( 34 )$$

$$Cc ( Aa , Ba ) := 10 \cdot Aa + \frac{Asw ( Aa , Ba )}{2} - 4 \cdot Vsw ( Aa , Ba ) \qquad ( 35 )$$

for the constant 1s Ac Bc and Cc as functions of Aa and Ba, and the final chosen function for the swing (angular) motion (position) of the link entering the curve is then:

Fsw(Aa,Ba,x):=Ac(Aa,Ba)·x⁵+Bc(Aa,Ba)·x⁴+Cc(Aa,Ba)·x³ (36)

which, by giving the angular position of the entering link (and thus the position over time of the leading hinge axis of the entering link), traces out the first half the of the turn.

A parametric curve for the hinge axis path from the end of the input straight section to the point P is then given by, for x from 0 to 1:

x2(Aa,Ba,x):=x+cos(Fsw(Aa,Ba,x)) (37)

y2(Aa,Ba,x):=−sin(Fsw(Aa,Ba,x)) (38)

A parametric line of departure from the turn, along the straight line of departure of the hing axes, is given by:

y1(Aa,Ba,x):=−(sin(Aa)+sin(Ba−An)+x·sin(Ba)) (39)

x1(Aa,Ba,x):=cos(Aa)+cos(Ba−Aa)+x·cos(Ba)+1 (40)

A parametric intersection of circles of radius 1 centered on the coordinates (39) and (40) can be given by:

$$proportion ( Aa , Ba , x ) := \frac{( \sqrt{4 - {( y 1 ( Aa , Ba , x ) - y 2 ( Aa , Ba , x ) )}^{2} - {( x 1 ( Aa , Ba , x ) - x 2 ( Aa , Ba , x ) )}^{2}}}{2 \cdot \sqrt{{( x 1 ( Aa , Ba , x ) - x 2 ( Aa , Ba , x ) )}^{2} + {( y 1 ( Aa , Ba , x ) - y 2 ( Aa , Ba , x ) )}^{2}}} \qquad ( 41 )$$

$$x 3 ( Aa , Ba , x ) := \frac{x 2 ( Aa , Ba , x ) + x 1 ( Aa , Ba , x )}{2} + ( y 2 ( Aa , Ba , x ) - y 1 ( Aa , Ba , x ) ) \cdot proportion ( Aa , Ba , x ) \qquad ( 42 )$$

$$y 3 ( Aa , Ba , x ) := \frac{y 2 ( Aa , Ba , x ) + y 1 ( Aa , Ba , x )}{2} + ( x 2 ( Aa , Ba , x ) - x 1 ( Aa , Ba , x ) ) \cdot proportion ( Aa , Ba , x ) \qquad ( 43 )$$

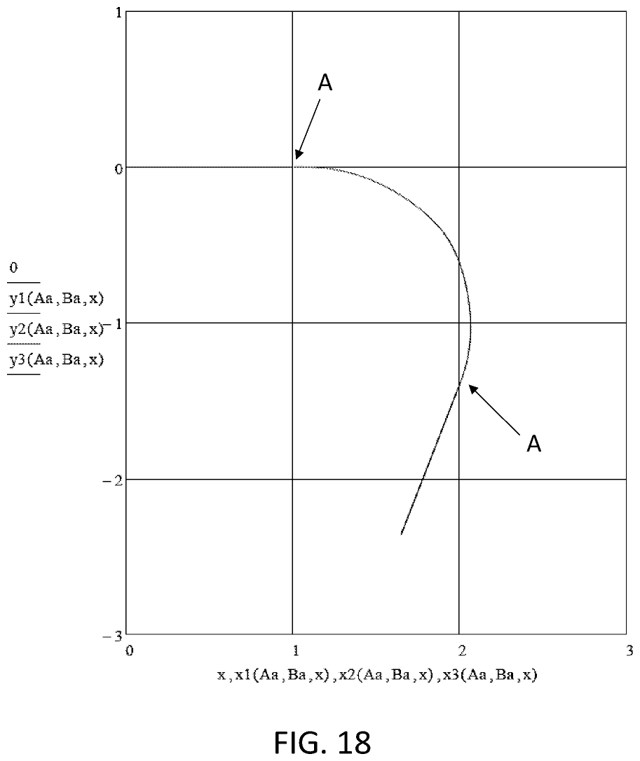

The resulting transition curve for the hinge axes to follow for the inputs Ba=110 degrees and Aa=25 degrees is shown in FIG. 18. The transition region is between the locations indicated by the arrows A, and allows a chain of links length l to transition smoothly around a 110 degree turn without any instantaneous changes in velocity or acceleration (parallel or perpendicular to the hinge axes' path) and while maintaining constant relative motion of the links before and after the turn (i.e., no speed variation in chain linear speed is produced). Transition curves of between one and two links length can be generated similarly, with the length of the initial portion of the curve (and the length of the curve of the initial found function satisfying the appropriate differential equation) shortened as needed.

If a symmetrical curve of between one and two link's length is desired, an alternate approach may be used. With reference again to FIG. 16, this alternate approach can take the form of first determining the center-most part the transition curve by plotting the point P, or in the case of a transition curve of less than two link lengths, by plotting a curve segment centered on point P as produced by the intersection of the entering and leaving links when both have one end on the respective entering and exiting (straight or otherwise) paths. The motion of the leading hinge axis of the entering link and the trailing hinge axis of the leaving departing link are than found at point P (as in the example above), or at the endpoints of the curve segment in the case of a shorter transition curve. Differential equations are then found for both the entering and departing links' motion in order to satisfy the required position, velocity, and accelerations at point P or at the endpoints of the segment, and are selected so as to be symmetrical about the point P or the (central) curve segment. Finally, the parts of the curve other than point P or other than on the (central) curve segment are found by stepping the motion of a link through one-half of the parts of the curve other than point P, or other than on the (central) curve segment while enforcing the desired motion of hinge axes on the entering and exiting straight paths and minimizing a total position error (simultaneously) at both hinge axes of a link wholly on the transition curve relative to the previously determined symmetrical differential functions, using any suitable selected error function (such as distance or distance squared, for instance). The resulting minimized error curve (for the link hinges to travel) is a symmetrical transition curve greater than one link and up to two links in length, in which no instantaneous changes in velocity or acceleration are produced (parallel or perpendicular to the hinge axes' path) while maintaining constant relative motion of the links before and after the turn. These techniques for using more than one and up to two link lengths for a transition curve can also be applied to transitioning from straight to curved motion or from one curved motion to another, as further variations on the present disclosure, if the most compact (single-link length) transitions are not needed or are for some reason undesirable in a particular case.

Important applications of the present disclosure can include smooth drives for chains and chain-like conveyor systems, particularly where high speed or lowest impact is desired. Chain circuits using sprocket drives and circular idler turns and/or non-circular turns as described herein have the smoothness produced by high uniformity of motion and lack of sudden changes in both velocity and acceleration. This corresponds to a chain path (a path of the hinge axes of the chain) having (1) no discontinuities of tangency along the path (i.e., no sudden or instantaneous changes of direction) and (2) having no discontinuities of curvature along the path. Furthermore, circuits where all curves are one or more of the forms described have effectively constant length as seen by the chain. In other words, the effective length of the circuit does not vary depending on, or is independent of, the relative phase position of the chain links on the circuit. Accordingly, pre-tensioning can be employed to eliminated backlash, as tension does not increase or decrease dependent on the relative position of the links. And where only rolling elements are used for guiding and engaging, a fully rolling element anti-backlash drive may be produced.

These and other advantages will be apparent to those of skill in the relevant arts. Embodiments are examples and not meant to limit the scope to particular instances of the described subject matter.

What is claimed is:

1. A link chain system comprising:
a guided endless chain having multiple links, the links having hinge axes where they join with neighboring links, the links having a length L between the respective hinge axes of the links;
a chain path along which the hinge axes are guided when driven by a drive wheel or sprocket or by any external drive;
the chain path having no discontinuities of curvature and no discontinuities of tangency; and
the chain path having a constant length in links L independent of the relative phase position of the links of chain along the path.

2. The link chain system of claim 1 further comprising a drive sprocket or drive wheel and transition curves of the chain path to and from the drive sprocket or drive wheel.

3. The link chain system of either claim 1 or claim 2 further comprising a straight-to-straight transition curve of the chain between a first straight portion of the chain and a second straight portion of the chain path, the straight-to-straight transition curve having a length measured in lengths of link length L of greater than one and not more than two.
